(19) United States
(12) Patent Application Publication
(10) Pub. No.: US 2025/0189140 A1
(43) Pub. Date: Jun. 12, 2025

(54) RANGE HOOD INCLUDING CAMERA AND CONTROLLING METHOD THEREOF

(71) Applicant: Samsung Electronics Co., Ltd., Suwon-si (KR)

(72) Inventors: Gichan LEE, Suwon-si (KR); Heechan KANG, Suwon-si (KR); Jeonguk PARK, Suwon-si (KR); Hyukbin JO, Suwon-si (KR)

(21) Appl. No.: 19/056,202

(22) Filed: Feb. 18, 2025

Related U.S. Application Data
(63) Continuation of application No. PCT/KR2023/014145, filed on Sep. 19, 2023.

(30) Foreign Application Priority Data
Oct. 12, 2022 (KR) 10-2022-0130835

(51) Int. Cl. F24C 15/20

(52) U.S. Cl. CPC F24C 15/2021; F24C 15/2042

(57) ABSTRACT

A range hood and a controlling method thereof are provided. The range hood includes a camera, a communication interface, a fan, a filter for purifying air drawn into the range hood by driving the fan, memory storing one or more computer programs, and one or more processors communicatively coupled to the camera, the communication interface, the fan, the filter, and the memory, wherein the one or more computer programs include computer-executable instructions that, when executed by the one or more processors individually or collectively, cause the range hood to transmit an image of a cooking object obtained through the camera to a server via the communication interface, based on a first correction coefficient obtained based on a type of food and a cooking method corresponding to the cooking object being received from the server, identify a usage time of the filter corresponding to the food based on the first correction coefficient and a running time of the fan, and identify when to replace the filter based on the usage time of the filter and a cumulative usage time of the filter.

### CROSS-REFERENCE TO RELATED APPLICATION(S)

This application is a continuation application, claiming priority under 35 U.S.C. § 365(c), of an International application No. PCT/KR2023/014145, filed on Sep. 19, 2023, which is based on and claims the benefit of a Korean patent application number 10-2022-0130835, filed on Oct. 12, 2022, in the Korean Intellectual Property Office, the disclosure of which is incorporated by reference herein in its entirety.

### BACKGROUND

### 1. Field

The disclosure relates to a range hood and a controlling method thereof. More particularly, the disclosure relates to a range hood including a camera and a controlling method thereof.

### 2. Description of Related Art

In most restaurants and home kitchens, a range hood is installed along with a cooking appliance. A cooking appliance is an appliance that heats a cooking container through at least one heating device, such as a gas range, induction range, or Highlight Electric Range.

A range hood is a device that sits above the cooking appliance (i.e., in the opposite direction of gravity) to exhaust smoke, vapors, odors, etc. from the cooking process to the outside of the restaurants or homes. To this end, the range hood drives a fan to draw in air containing smoke, vapor, odor, etc. from the cooking process. In this case, the air sucked in by the fan is filtered by a filter. The air generated during the cooking process contains impurities such as grease, etc. Therefore, if this filtering process is not performed, impurities such as grease can be adsorbed on the fan, motor, etc. of the range hood, which can lead to the failure of the range hood. However, the filter of a range hood loses its purifying power over time, so it is necessary to clean or replace the filter periodically.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a range hood including camera and controlling method thereof.

Additional aspects will be set forth in part in the description which follows and, in part, will be apparent from the description, or may be learned by practice of the presented embodiments.

In accordance with an aspect of the disclosure, a range hood is provided. The range hood includes a camera, a communication interface, a fan, a filter for purifying air drawn into the range hood by driving the fan, memory storing one or more computer programs, and one or more processors communicatively coupled to the camera, the communication interface, the fan, the filter, and the memory, wherein the one or more computer programs include computer-executable instructions that, when executed by the one or more processors individually or collectively, cause the range hood to transmit an image of cooking object obtained through the camera to a server via the communication interface, based on a first correction coefficient obtained based on a type of food and a cooking method corresponding to the cooking object being received from the server, identify a usage time of the filter corresponding to the food based on the first correction coefficient and a running time of the fan, and identify when to replace the filter based on the usage time of the filter and a cumulative usage time of the filter.

In accordance with another aspect of the disclosure, a controlling method performed by a range hood including a camera is provided. The controlling method includes transmitting, by the range hood, an image of cooking object obtained through the camera to a server through a communication interface of the range hood, receiving, by the range hood, a first correction coefficient obtained based on a type of food and a cooking method corresponding to the cooking object from the server, identifying, by the range hood, a usage time of a filter of the range hood corresponding to the food based on the first correction coefficient and a running time of a fan of the range hood and identifying, by the range hood, when to replace the filter based on the usage time of the filter.

In accordance with another aspect of the disclosure, one or more non-transitory computer-readable storage media storing one or more computer programs including computer-executable instructions that, when executed by one or more processors of a range hood individually or collectively, cause the range hood to perform operations are provided. The operations include transmitting, by the range hood, an image of a cooking object obtained through a camera to a server through a communication interface of the range hood, receiving, by the range hood, a first correction coefficient obtained based on a type of food and a cooking method corresponding to the cooking object from the server, identifying, by the range hood, a usage time of a filter of the range hood corresponding to the food based on the first correction coefficient and a running time of a fan of the range hood, and identifying, by the range hood, when to replace the filter based on the usage time of the filter and a cumulative usage time of the filter.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a range hood according to an embodiment of the disclosure;

FIG. 2 is a block diagram illustrating configuration of a range hood according to an embodiment of the disclosure;

FIG. 3 is a view provided to explain a method of identifying a type of food and a cooking method through a camera according to an embodiment of the disclosure;

FIG. 4 is a view illustrating a table of correction coefficients corresponding to a type of food and a cooking method according to an embodiment of the disclosure;

FIG. 5 is a view illustrating a neural network model trained to output a correction coefficient corresponding to a type of food and a cooking method according to an embodiment of the disclosure;

FIG. 6 is a view provided to explain identifying a usage time of a filter based on a correction coefficient based on a type and a cooking method according to an embodiment of the disclosure;

FIG. 7 is a view provided to explain identifying a usage time of a filter based on a correction coefficient corresponding to a type and a cooking method and a correction efficient corresponding to a rotation speed of a fan according to an embodiment of the disclosure;

FIG. 8 is a view provided to explain applying a correction coefficient to one of a running time of a fan and a cooking time of food according to an embodiment of the disclosure;

FIG. 9 is a detailed block diagram illustrating configuration of a range hood according to an embodiment of the disclosure;

FIGS. 10 to 13 are flowcharts provided to explain a controlling method of a range hood including a camera according to various embodiments of the disclosure; and

FIG. 14 is a sequence view provided to explain an operation between a range hood including a camera included in a cooking system and a server according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Therefore, the terms used in the embodiments of the disclosure need to be defined on the basis of the meanings of the terms and the overall contents throughout the disclosure rather than simple names of the terms.

In the disclosure, the expressions “have”, “may have”, “include” or “may include” indicate existence of corresponding features (e.g., components such as numeric values, functions, operations, or components), but do not exclude presence of additional features.

An expression, “at least one of A or/and B” should be understood as indicating any one of “A”, “B” and “both of A and B.”

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In embodiments, a “module” or a “unit” may perform at least one function or operation, and be implemented as hardware or software or be implemented as a combination of hardware and software. In addition, a plurality of “modules” or a plurality of “units” may be integrated into at least one module and be implemented as at least one processor (not shown) except for a ‘module’ or a ‘unit’ that needs to be implemented as specific hardware.

In this specification, the term ‘user’ may refer to a person using an electronic device or an apparatus using an electronic device (e.g., an artificial intelligence electronic device).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

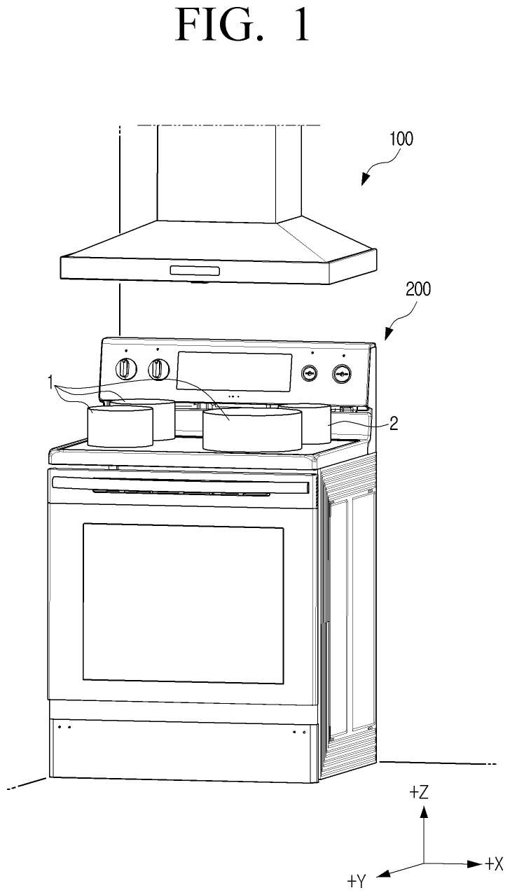

FIG. 1 is a perspective view of a range hood according to an embodiment of the disclosure.

FIG. 1 is a schematic perspective view of a range hood 100 and a cooking appliance 200.

Referring to FIG. 1, the range hood 100 may be positioned above the top plate of the cooking appliance 200 (e.g., in the +z axis direction). The range hood 100 drives a fan 130 to suck in the surrounding air of the range hood 100 and then discharges it to the outside in order to remove smoke, dust, cooking vapor, or cooking odor generated from a cooking container 2 placed on a heating device of the cooking appliance 200.

In this case, the air sucked in by the fan 130 is filtered by a filter 140 of the range hood 100. The air generated in the process of cooking a cooking object 1 (e.g., food ingredients, food, etc.) in the cooking container 2 may contain impurities such as grease, etc. which may be adsorbed into the fan 130, the motor, etc. of the range hood 100 and cause the range hood 100 to fail. Therefore, the range hood 100 performs a filtering process on the air being drawn into the range hood 100 using the filter 140 to remove impurities in the air.

Meanwhile, as the cumulative usage time of the filter 140 increases, the purifying power of the filter 140 decreases. Therefore, the filter 140 of the range hood 100 should be cleaned and/or replaced at appropriate intervals. However, relying solely on the cumulative usage time of the filter 140 to determine when to clean or replace the filter 140 may be inaccurate. This is because the amount of smoke, dust, and cooking vapor generated from the cooking container 2 may vary depending on the object in the cooking container 2 (e.g., food ingredients, food, etc.), which is being cooked in the cooking appliance 200 or depending on the cooking method (e.g., boiling, stir-frying, deep-frying, etc.), and the type and amount of impurities contained in the air may also vary.

Therefore, the range hood 100 according to an embodiment utilizes a camera 110 to identify the type of food and the cooking method corresponding to the cooking object 1 that is being cooked in the cooking appliance 200, and then appropriately identifies the usage time of the filter 140 based on the identified type and cooking method of the food. In other words, the disclosure dos not consider only the usage time of the filter 140, but also identifies the usage time of the filter 140 by considering the characteristics of the air passing through the filter 140 (air quality, impurities in the air, etc.), which vary depending on the type of food that is being cooked in the cooking process and the cooking method thereof.

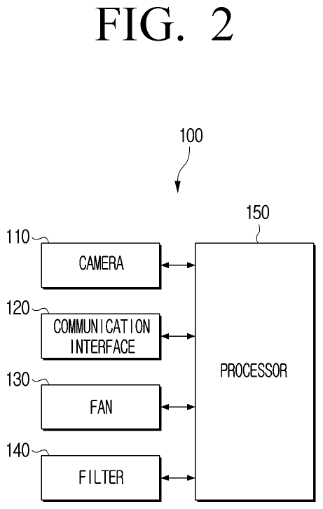

Hereinafter, an embodiment of a range hood including a camera will be described in detail with reference to FIGS. 2 to 9.

FIG. 2 is a block diagram illustrating configuration of a range hood according to an embodiment of the disclosure.

Referring to FIG. 2, the range hood 100 according to an embodiment includes the camera 110. The camera 110 is disposed on a heating device of the cooking appliance 200 disposed below (e.g., in the −z direction) the range hood 100 to photograph the cooking object 1 which is being cooked in the cooking appliance 200. Subsequently, the camera 110 obtains an image 10 of the cooking object 1.

To this end, the camera 110 may be implemented as an imaging device, such as a CMOS image sensor (CIS) with a CMOS structure, a charge coupled device (CCD) with a CCD structure, and the like. However, the camera 110 is not limited thereto, and the camera 110 may be implemented as a camera 110 module with various resolutions, which is capable of photographing the cooking container 2 and the cooking object 1 in the cooking container 2. Meanwhile, the camera 110 may also be implemented as a depth camera 110 (e.g., an IR depth camera 110), a stereo camera 110, or an RGB camera 110.

The range hood 100 according to an embodiment includes the communication interface 120. The communication interface 120 performs communication with an external device to receive various types of data and information. For example, the communication interface 120 receives various types of data and information from home appliances (e.g. display devices, air conditioners, air purifiers, etc.), external storage media (e.g. USB memory), external servers (e.g. web hard), etc. through a communication method such as an access point (AP)-based wireless fidelity (Wi-Fi, wireless local area network (LAN)), a Bluetooth, a Zigbee, a wired/wireless local area network (LAN), a wide area network (WAN), Ethernet, an IEEE 1394, a high definition multimedia interface (HDMI), a USB, a mobile high-definition link (MHL), audio engineering society/European broadcasting union (AES/EBU) communication, optical communication, coaxial communication, etc.

In particular, the communication interface 120 according to an embodiment may perform communication with a server 300 that is linked to the range hood 100. Specifically, the communication interface 120 may transmit the image 10 of the cooking object 1 obtained through the camera 110 to the server 300. In addition, the communication interface 120 may receive from the external server 300 the results of an analysis of the cooking object 1 in the image 10. In one example, the communication interface 120 may receive information from the external server 300 regarding the type of food and the cooking method corresponding to the cooking object 1 in the image 10 identified by analyzing the image 10 transmitted to the external server 300.

The range hood 100 according to an embodiment includes the fan 130. In one example, the range hood 100 may include the fan 130 that draws in the surrounding air through a duct and discharges it to the outside. The range hood 100 may rotate the fan 130 to draw the surrounding air into the range hood 100 and discharge it to the outside. Accordingly, smoke, dust, cooking vapor, cooking odor, etc. generated during the cooking process can be removed or reduced in concentration. The fan 130 of the range hood 100 may be connected to a motor. In this case, as the rotation speed of the motor changes, the rotation speed of the fan 130 may also change.

The range hood 100 according to an embodiment includes a filter 140. The filter 140 purifies the air that is drawn into the range hood 100 by driving the fan 130. To this end, the filter 140 may be provided in air path of an intake port formed on one side of a duct of the range hood 100 and an exhaust port formed on the other side, and may be mounted on a front portion of the fan 130 to purify the air being sucked into the fan 130.

The one or more processors 150 according to an embodiment performs the overall control operations of the range hood 100.

The one or more processors 150 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 150 may control one or any combination of the other components of the electronic device, and may perform communication-related operations or data processing. The one or more processors 150 may execute one or more programs or instructions stored in memory (not shown). For example, the one or more processors 150 performs a method according to an embodiment by executing one or more instructions stored in the memory.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 150 may be implemented as a single core processor comprising a single core, or as one or more multicore processors including a plurality of cores (e.g., homogeneous multicore or heterogeneous multicore). When the one or more processors 150 are implemented as a multicore processor, each of the plurality of cores included in the multicore processor may include an internal memory of the processor 150, such as cache memory and on-chip memory, and a common cache shared by the plurality of cores may be included in the multicore processor. Each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the disclosure, the processor 150 may mean a system-on-chip (SoC) in which one or more processors and other electronic components are integrated, a single-core processor, a multi-core processor, or a core included in a single-core processor or multi-core processor, and the core may be implemented as CPU, GPU, APU, MIC, DSP, NPU, hardware accelerator, or machine learning accelerator, etc., but the core is not limited to the embodiments of the disclosure.

Hereinafter, for convenience of description, the one or more processors 150 will be referred to as a processor.

The processor 150 according to an embodiment transmits the image 10 of the cooking object 1 obtained through the camera 110 to the server 300 via the communication interface 120.

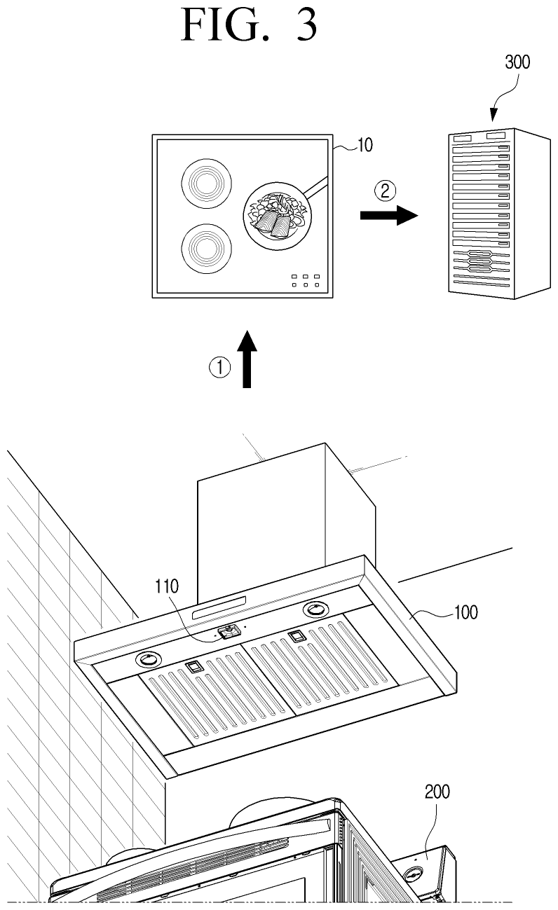

FIG. 3 is a view provided to explain a method of identifying a type and a cooking method corresponding to a cooking object through a camera according to an embodiment of the disclosure.

Referring to FIG. 3, the processor 150 may photograph, through the camera 110, the cooking object 1 which is being cooked in the cooking container 2 disposed on a heating unit of the cooking appliance 200 disposed below (e.g., along the −z axis) of the range hood 100, and obtain the image 10 of the cooking object 1.

Specifically, the processor 150 may control the camera 110 to obtain the captured image 10 at preset intervals (e.g., 100 ms, 1 sec, 3 sec). In this case, the processor 150 may capture a video of the top of the cooking appliance 200 located below the range hood 100, and may detect a change in the top of the cooking appliance 200 (e.g., the cooking container 2 is placed on a heating device disposed on the top of the cooking appliance 200, or the cooking object 1 in the cooking container 2 is detected). Subsequently, when a change in the top surface of the cooking appliance 200 is detected, the processor 150 may obtain the captured image 10 of the top surface of the cooking appliance 200, thereby obtaining obtain the image 10 of the cooking object 1.

In one example, upon receiving a user input to control the camera 110 via the communication interface 120 of the range hood 100 or an input interface (not shown) (e.g., a control panel provided on the range hood 100), the processor 150 may control the camera 110 to obtain the captured image 10 of the cooking object 1 in the cooking container 2.

In addition, in one example, when the cooking container 2 is detected below the range hood 100 (i.e., on a heating device disposed on top of the cooking appliance 200) via a sensor (e.g., a Lidar sensor, a temperature sensor, etc.), the processor 150 may control the camera 110 to obtain the image 10 of the cooking container 2 and the cooking object 1 in the cooking container 2. For example, when the temperature of the air being drawn in by the range hood 100 is above a preset temperature based on a temperature sensor, the processor 150 may identify that a heating device of the cooking appliance 200 is operated, and may identify that the cooking process for the cooking object 1 in the cooking container 2 on the heating device has started. Accordingly, the processor 150 may photograph the cooking object 1 using the camera 110 to obtain an image of the cooking object 1.

Further, in one example, the processor 150 may perform communication with the cooking appliance 200 via the communication interface 120, and upon receiving start information of the cooking appliance 200 from the cooking appliance 200 via the communication interface 120, the processor 150 may photograph the cooking appliance 200 disposed below the range hood 100 through the camera 110. Accordingly, the processor 150 may obtain the image 10 of the cooking object 1. The cooking start information may include at least one of whether the cooking container 2 is detected on the heating device disposed on the top of the cooking appliance 200 or whether the heating device is turned on.

Meanwhile, prior to transmitting the image 10 of the cooking object 1 obtained through the camera 110 to the server 300 via the communication interface 120, the processor 150 may process the obtained image 10. For example, the processor 150 crops a portion of the obtained image 10, which corresponds to an area of the cooking container 2 in the obtained image 10.

To this end, the processor 150 may pre-acquire an image in which the cooking container 2 is not disposed on the heating device disposed on the top of the cooking appliance 200, stored in the memory of the range hood 100, and then compare the stored image with an obtained image (i.e., the image 10 of the cooking object 1) obtained through the camera 110 to detect an area of the cooking container 2 in the obtained image 10.

Meanwhile, according to an embodiment, the processor 150 may obtain a plurality of images 10 of the cooking object 1 by repeatedly photographing the cooking container 2 disposed on the top of the cooking appliance 200 and the cooking object 1 in the cooking container 2 through the camera 110 at preset intervals. Subsequently, the processor 150 may transmit the obtained plurality of images 10 of the cooking object 1 to the server 300 via the communication interface 120.

Referring back to FIG. 3, after obtaining the image 10 of the cooking object 1 through the camera 110, the processor 150 transmits the obtained image 10 of the cooking object 1 to the server 300 via the communication interface 120.

Meanwhile, FIG. 3 illustrates that the cooking object 1 is a food item. However, the disclosure is not limited thereto, and the cooking object 1 in the image 10 obtained by the processor 150 may also include any food ingredients.

According to an embodiment, when receiving from the server 300 a correction coefficient obtained based on the type of food and the cooking method corresponding to the cooking object 1, the processor 150 identifies the usage time of the filter 140 corresponding to the food based on the correction coefficient and the running time of the fan 130.

The correction coefficient is a coefficient applied to the usage time of the filter 140 to adjust the usage time of the filter 140. Specifically, depending on the type of food and the cooking method, the characteristics of the air generated during the cooking process (e.g., the type and amount of impurities in the air and the amount of smoke, vapor, etc.) may vary. Thus, even if the filter 140 performs the filtering process of the air drawn in by the fan 130 for the same amount of time, the level of contamination and damage to the filter 140 may vary depending on the type of food and the cooking method. Accordingly, the correction coefficient is a coefficient for adjusting the usage time of the filter 140 in consideration of the characteristics of the air according to the type of food and the cooking method.

For example, in the case of the type of food and cooking method that generate a high level of impurities in the air, the correction coefficient is a value that increases the usage time of the filter 140. Meanwhile, hereinafter, for convenience of description, the correction coefficient obtained based on the type of food and the cooking method is referred to as a first correction coefficient.

The processor 150 may receive from the server 300 the first correction coefficient corresponding to the type of food and the cooking method corresponding to the cooking object 1 in the image 10. Specifically, when the cooking container 2 contains finished food, or when the cooking container 2 contains food that is being cooked, the type of food may be identified by recognizing the food by the server 300. On the other hand, when the cooking container 2 contains an ingredient, the server 300 may identify the type of the ingredient and then identify the type of the food based on the identified type of the ingredient. Alternatively, the server 300 may receive a plurality of images 10 of ingredients from the processor 150 of the range hood 100 and observe the process of changing the ingredients or completing the food during the cooking process to identify the type of food.

The cooking method may be identified by the server 300 based on the identified type of food. For example, when it is identified that the type of food is chicken, the server 300 identifies the cooking method as “deep-fry”. In this case, depending on the type of food, the server 300 may identify a plurality of cooking methods. For example, when it is identified that the type of food is pasta, the server 300 identifies the cooking method as “boil” and “stir-fry”.

Meanwhile, in order to identify the type of food and the cooking method corresponding to the cooking object 1, the image 10 of the cooking object 1 transmitted by the processor 150 to the server 300 via the communication interface 120 may be input to a neural network model by the server 300. The neural network model may be a neural network model trained based on training data consisting of a plurality of images 10 including food or food ingredients. Specifically, the neural network model may be trained (e.g., supervised learning) with each image 10 as an input value and the type of food corresponding to the food or food ingredients included in each image 10 as an output value. However, the neural network model is not limited thereto, and the neural network model may be an unsupervised neural network model trained based on training data consisting of a plurality of images 10 including food or food ingredients.

The neural network model may use various networks such as Deep Neural Networks (DNNs), Convolutional Neural Networks (CNNs), Recurrent Neural Networks (RNNs), Restricted Boltzmann Machines (RBMs), Deep Belief Networks (DBNs), Deep Q-Networks (DQNs), and more.

Hereinafter, for convenience of explanation, the neural network model trained to identify the type of food and the cooking method corresponding to the cooking object 1 included in the image 10 will be referred to as a first neural network model.

Meanwhile, the first correction coefficient may be a correction coefficient corresponding to the type of food and the cooking method of the food obtained from the image 10 among a plurality of correction coefficients corresponding to a plurality of food types and cooking methods.

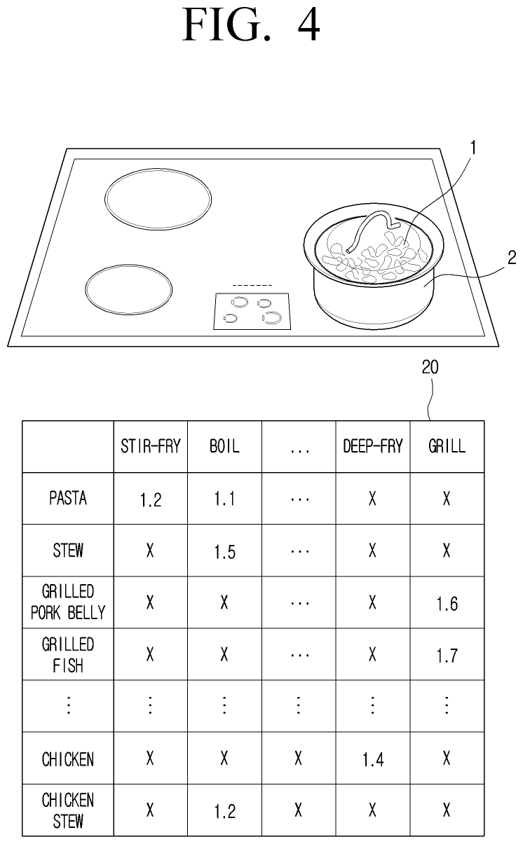

FIG. 4 is a view illustrating a table of correction coefficients corresponding to a type of food and a cooking method according to an embodiment of the disclosure.

Referring to FIG. 4, the first correction coefficient may be obtained based on a table 20 that includes a plurality of correction coefficients corresponding to a plurality of food types and cooking methods. When the type of food and the cooking method of the cooking object 1 in the image 10 are identified by the server 300, the first correction coefficient may be obtained as a correction coefficient corresponding to the identified food type and cooking method from among a plurality of correction coefficients included in the table 20.

For example, when the type of food and the cooking method corresponding to the cooking object 1 in the image 10 transmitted by the processor 150 to the server 300 via the communication interface 120 are identified as grilled fish and grilling, respectively, the first correction coefficient is identified by the server 300 as 1.7, which is the correction coefficient corresponding to grilled fish and grilling from among a plurality of correction coefficients in the table 20. Accordingly, the processor 150 may receive the first correction coefficient of 1.7 from the server 300 via the communication interface 120.

Meanwhile, in one example, the table 20 including a plurality of correction coefficients corresponding to a plurality of food types and cooking methods may be stored in the memory of the range hood 100. Accordingly, when the processor 150 receives information from the server 300 via the communication interface 120 regarding a type of food and a cooking method corresponding to the cooking object 1 in the image 10, the processor 150 may identify a correction coefficient corresponding to the received type of food and cooking method in the table 20 including the plurality of correction coefficients.

Further, according to an embodiment, the first correction coefficient may be obtained by inputting a type of food and a cooking method obtained from the image 10 into a neural network model trained based on a type of food and a cooking method and a correction coefficient corresponding to the type of food and the cooking method.

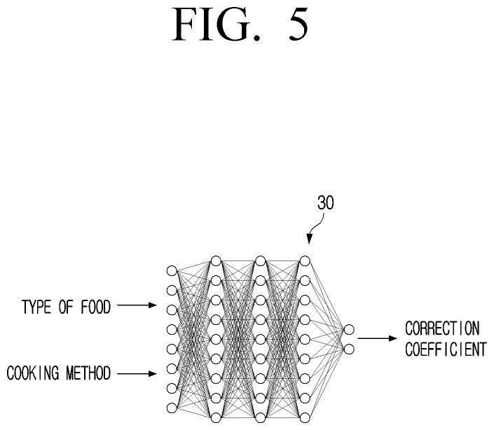

FIG. 5 is a view illustrating a neural network model trained to output a correction coefficient corresponding to a type of food and a cooking method according to an embodiment of the disclosure.

Referring to FIG. 5, the first correction coefficient may be identified as a correction coefficient that is output as the type of food and the cooking method corresponding to the cooking object 1 in the image 10 transmitted by the processor 150 is input to a neural network model 30. In this case, the neural network model 30 may be a neural network model trained to, when a type of food and a cooking method are input to the neural network model 30, output a correction coefficient corresponding to the type of food and the cooking method. Specifically, the neural network model 30 may be trained to output an appropriate correction coefficient, taking into account the level of air contamination (e.g., the type and amount of impurities in the air, etc.) generated by the respective food types and cooking methods.

To this end, the neural network model 30 may be trained based on training data including a plurality of food types and cooking methods and a plurality of correction coefficients corresponding to the food types and cooking methods. In one example, the neural network model 30 may be trained based on a plurality of food types and cooking methods and a plurality of correction coefficients included in the table 20 as illustrated in FIG. 4. Accordingly, when the type of food and the cooking method identified in response to the cooking object 1 in the image 10 transmitted by the processor 150 are not the type of food and the cooking method included in the table 20, the first correction coefficient may be obtained as the type of food and the cooking method identified by the server 300 are input into the neural network model 30.

Meanwhile, in one example, the neural network model 30 trained to output a correction coefficient corresponding to a type of food and a cooking method may be stored in the memory of the range hood 100. Accordingly, when receiving information from the server 300 via the communication interface 120 regarding a type of food and a cooking method corresponding to the cooking object 1 in the image 10, the processor 150 may input the received type of food and cooking method into the neural network model 30 to obtain the first correction coefficient.

Hereinafter, for convenience of explanation, the neural network model 30 trained to output a correction coefficient corresponding to a type of food and a cooking method is referred to as a second neural network model.

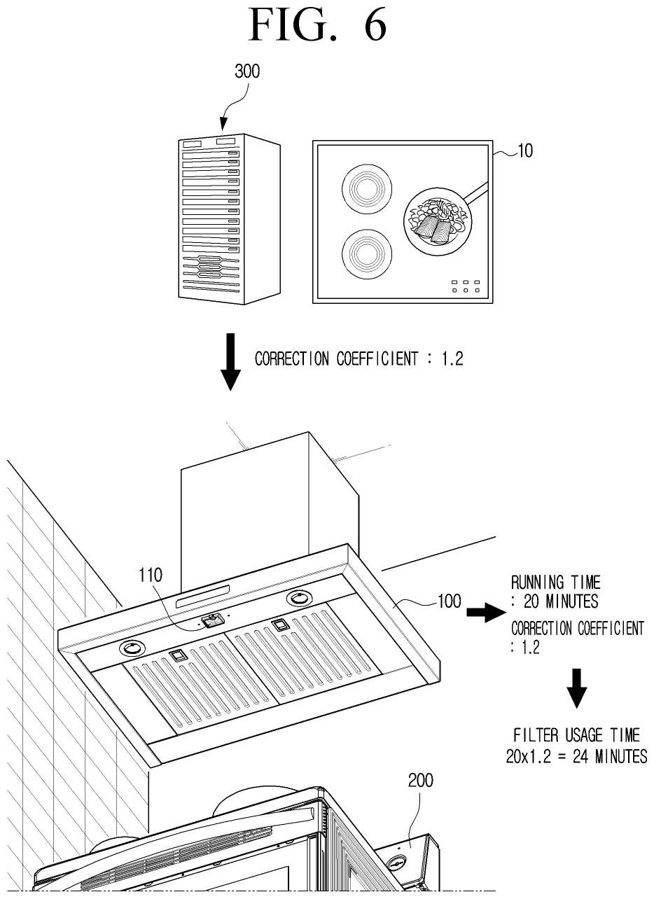

FIG. 6 is a view provided to explain identifying a usage time of a filter based on a correction coefficient based on a type and a cooking method according to an embodiment of the disclosure.

Referring to FIG. 6, upon receiving the first correction coefficient obtained in accordance with the above-described embodiment, the processor 150 identifies a usage time of the filter 140 corresponding to the cooking object 1 based on the first correction coefficient and the running time of the fan 130.

The running time of the fan 130 may be the time that the fan 130 is operated while the cooking object 1 in the image 10 transmitted by the processor 150 to the server 300 via the communication interface 120 is being cooked. When receiving the first correction coefficient, the processor 150 may identify the time that the fan 130 is operated while the cooking object 1 is being cooked. The processor 150 may identify the time taken from the time when the fan 130 starts rotating after the range hood 100 is turned on to the time when the range hood 100 is turned off or the fan 130 that is rotating according to a user's input stops as the running time of the fan 130. For example, when the fan 130 temporarily stops operating during the cooking process of the cooking object 1, the processor 150 calculates the total operating time of the fan 130 by adding up the time when the fan 130 starts operating and stops and the time when the fan 130 starts operating and stops again.

Meanwhile, the processor 150 may identify the usage time of the filter 140 corresponding to the cooking object 1 by applying the first correction coefficient to the running time of the fan 130. The usage time of the filter 140 corresponding to the cooking object 1 may be the time corresponding to the level of damage or contamination of the filter 140 that performed the filtering process, taking into account the degree of contamination of the air (e.g., the type and amount of impurities in the air), smoke, odor, etc. generated from the cooking container 2 according to the type of food and the cooking method corresponding to the cooking object 1.

According to an embodiment, the processor 150 identifies when to replace the filter based on the usage time of the filter 140 and the cumulative usage time of the filter 140.

The cumulative usage time of the filter 140 may be the cumulative time the filter 140 is used before the cooking object 1 in the image 10 is cooked. The cumulative usage time of the filter 140 may be stored in the memory of the range hood 100.

In this case, the processor 150 may update the cumulative usage time of the filter 140 each time the filter 140 is replaced. In one example, when detecting that the filter 140 has been replaced (or when the processor 150 detects that the filter 140 has been cleaned), the processor 150 resets the cumulative usage time of the filter 140 stored in the memory. Subsequently, when the replaced filter 140 performs the filtering process as the fan 130 is operated, the processor 150 may cumulatively identify the usage time of the new filter 140 and store it in the memory.

According to an embodiment, the processor 150 may identify the usage time of the filter 140 by applying the first correction coefficient to the running time of the fan 130. When the sum of the usage time of the filter 140 and the cumulative usage time of the filter 140 is equal to or greater than a preset time, the processor 150 may identify that it is time to replace the filter 140.

Referring to FIG. 6, when the processor 150 receives the first correction coefficient of 1.2 from the server 300 and identifies the running time of the fan 130 as 20 minutes, the processor 150 may identify the usage time of the filter 140 by multiplying the first correction coefficient of 1.2 by the running time of the fan 130, which is 20 minutes. In this case, the processor 150 may identify the usage time of the filter 140 used in the process of cooking the cooking object 1 as 24 minutes (20×1.2). Subsequently, the processor 150 may identify the total usage time of the filter 140 by summing the cumulative time applied to the range hood 100 and the usage time of the filter 140. For example, when the cumulative time of the filter 140 is 240 minutes and the preset time is 260 minutes, the processor 150 identifies that the sum of the usage time of the filter 140 (24 minutes) and the cumulative time of the filter 140 (240 minutes) exceeds the preset time (260 minutes). In other words, as the filter 140 is used by driving the fan 130 in the process of cooking the cooking object 1, the processor 150 may identify that the total usage time of the filter 140 (264 minutes) exceeds the preset time (260 minutes). Accordingly, the processor 150 may identify that it is time to replace the filter 140.

Meanwhile, the processor 150 may identify whether it is time to clean the filter 140 based on a usage time of the filter 140 and a cumulative usage time of the filter 140 combined. Specifically, when the sum of the usage time of the filter 140 and the cumulative usage time of the filter 140 is equal to or greater than a preset time, the processor 150 may identify that it is time to clean the filter 140, and in this case, the preset time for identifying whether it is time to clean the filter 140 may be different from a preset time for identifying whether it is time to replace the filter 140. For example, the processor 150 identifies that it is time to clean the filter 140 when the sum of the usage time of the filter 140 and the cumulative usage time of the filter 140 is equal to or greater than a preset first time and less than a preset second time, and may identify that it is time to replace the filter 140 when the sum of the usage time of the filter 140 and the cumulative usage time of the filter 140 is equal to or greater than the preset second time.

Meanwhile, according to an embodiment, when a plurality of cooking methods correspond to a type of food, the processor 150 may receive a plurality of first correction coefficients from the server 300 via the communication interface 120. Specifically, referring back to FIG. 4, in the case of pasta, “stir-frying” and “boiling” may be included in a plurality of cooking methods corresponding thereto.

In this case, the processor 150 may receive information on the cooking time required to perform each cooking method from the server 300. Specifically, the processor 150 may obtain the image 10 of the cooking object 1 through the camera 110 at preset intervals and then transmit it to the server 300 via the communication interface 120. In this case, the server 300 may identify not only the type of food completed during the cooking process of the cooking object 1 but also the cooking time required for each cooking method during the cooking process based on the image 10 transmitted at preset intervals.

Accordingly, the processor 150 may receive from the server 300 via the communication interface 120 a plurality of first correction coefficients corresponding to a plurality of cooking methods, respectively (e.g., a first correction coefficient corresponding to boiling of pasta (referred to as a 1-1 correction coefficient) and a second correction coefficient corresponding to boiling of pasta (referred to as a 1-2 correction coefficient)), together with information about the cooking time required for each cooking method.

Subsequently, the processor 150 may identify the usage time of the filter 140 for pasta by applying each of the first correction coefficients (the 1-1 correction coefficient and the 1-2 correction coefficient) to the respective cooking times. For example, referring to FIG. 4, when the cooking time for “stir-fry” is 10 minutes and the cooking time for “boil” is 5 minutes, the processor 150 identifies the usage time of the filter 140 during cooking the pasta as 17.5 minutes.

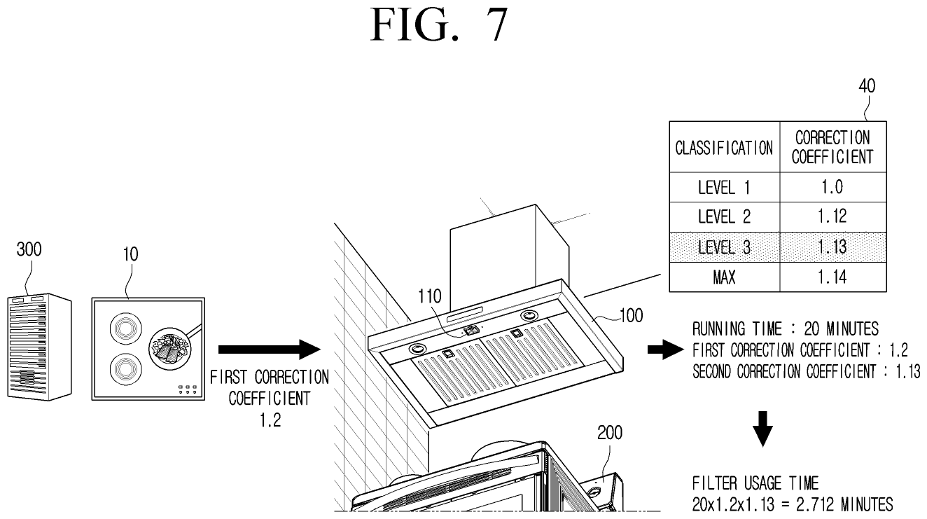

FIG. 7 is a view provided to explain identifying a usage time of a filter based on a correction coefficient corresponding to a type and a cooking method and a correction efficient corresponding to a rotation speed of a fan according to an embodiment of the disclosure.

In addition, according to an embodiment, the processor 150 may obtain a correction coefficient corresponding to a rotation speed of the fan 130 from among correction coefficients corresponding to a plurality of rotation speeds, and identify a usage time of the filter 140 corresponding to food by applying the first and second correction coefficients to the running time of the fan 130.

Specifically, the processor 150 may identify the usage time of the filter 140, taking into account the rotation speed of the fan 130 together with the type of food and the cooking method.

Specifically, when the rotation speed of the fan 130 is high, the filter 140 can perform a filtering process for a larger amount of air than when the rotation speed of the fan 130 is low. In other words, even if the fan 130 is operated for the same amount of time, the level of contamination or damage to the filter 140 will be greater when the rotation speed of the fan 130 is high than when the rotation speed of the fan 130 is low. Therefore, the processor 150 may identify the usage time of the filter 140 by further considering the rotation speed of the fan 130.

The memory of the range hood 100 may store a table 40 that includes a plurality of correction coefficients corresponding to a plurality of rotation speeds of the filter 140, respectively. Thus, the processor 150 may identify a rotation speed of the fan 130 driven while the cooking object 1 is being cooked, and may obtain a correction coefficient corresponding to the identified rotation speed in the table 40 stored in the memory. Hereinafter, for convenience of explanation, the correction coefficient obtained based on the rotation speed of the fan 130 will be referred to as a second correction coefficient.

Referring to FIG. 7, the processor 150 may identify a driving mode of the fan 130, which corresponds to a rotation speed of the fan 130 that is driven while the cooking object 1 is being cooked. In this case, when the driving mode of the fan 130 is identified as Level 3, the processor 150 may obtain a correction coefficient corresponding to Level 3, 1.13, in the table 40 as the second correction coefficient. Subsequently, the processor 150 may apply the first correction coefficient of 1.2 received from the server 300 and the obtained second correction coefficient of 1.13 to the running time of the fan 130 of 20 minutes, and identify the usage time of the filter 140 used in the process of cooking the cooking object 1 as 27.12 minutes.

Subsequently, the processor 150 may sum the identified 27.12 minutes with the cumulative usage time of the filter 140 to identify when to replace the filter 140. A description thereof will be omitted as it is equally applicable to the method described above.

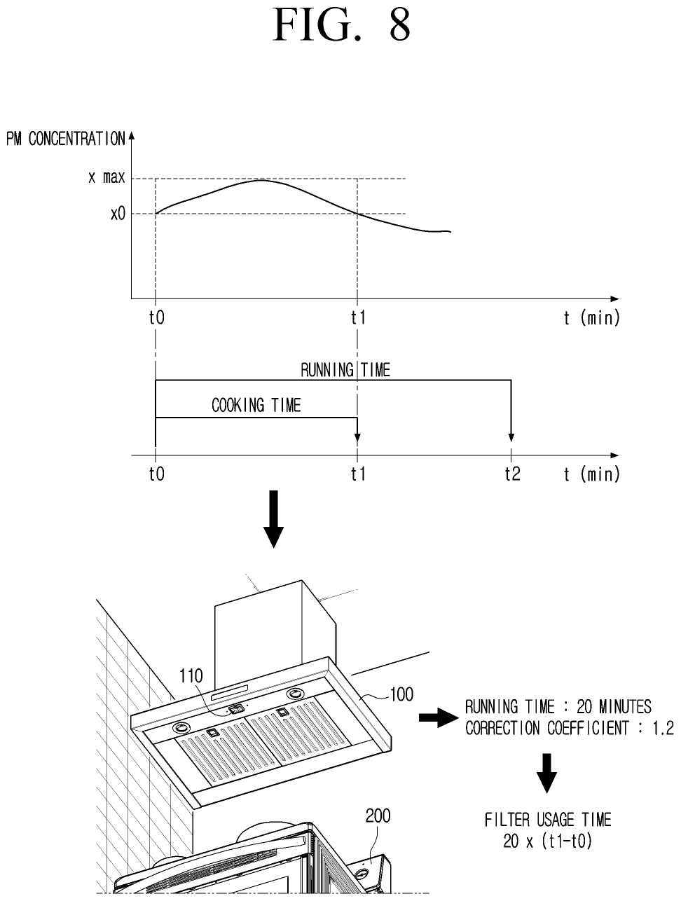

FIG. 8 is a view provided to explain applying a correction coefficient to one of a running time of a fan and a cooking time of food according to an embodiment of the disclosure.

According to an embodiment, the processor 150 may identify a cooking time of food based on the contamination level of the air being drawn into the range hood 100, and apply the first correction coefficient to one of the cooking time of the food and the running time of the fan 130 to identify the usage time of the filter 140 corresponding to the food.

The processor 150 may identify the time during which the filter 140 substantially performed a filtering process as the usage time of the filter 140. In other words, when the cooking process for the cooking object 1 is interrupted or the cooking process is terminated and the contamination level of the air no longer increases, the contamination level of the damage level of the filter 140 may not increase even if the fan 130 continues to operate. Accordingly, the processor 150 identifies the usage time of the filter 140 by considering only the time that the filter 140 substantially performed the filtering process. To this end, the processor 150 may identify the cooking time of the food based on the contamination level of the air, based on the identified cooking time, identify the time that the filter 140 substantially performed the filtering process.

Specifically, the processor 150 may identify the contamination level of the air using sensors of the range hood 100. In this case, the sensors may include an air quality measurement sensor, a smoke sensor, and the like.

In one example, the smoke sensor may detect a concentration of smoke generated from the cooking container 2. The processor 150 may measure the contamination level of the air based on the smoke concentration.

In one example, the air quality measurement sensor may measure the quality of air being drawn into the range hood 100 or the surrounding air of the range hood 100. The processor 150 may measure the contamination level of the air based on the air quality measured by the air quality measurement sensor.

For example, the air quality measurement sensor measures a concentration of at least one of PM 10, PM 2.5, PM 1.0, cooking vapor, or cooking odor. The PM 10 represents the concentration of suspended dust having a size of 10 micrometers, the PM 2.5 represents the concentration of suspended dust having a size of 2.5 micrometers, and the PM 1 represents the concentration of suspended dust having a size of 1.

Referring to FIG. 8, the processor 150 may identify the contamination level of the air by measuring the PM concentration of the air being drawn into the range hood 100 via an air quality measurement sensor. In this case, when the PM concentration of the air being drawn into the range hood 100 is less than a preset concentration (X₀) after the fan 130 starts running, the processor 150 may identify that the air being drawn into the range hood 100 has improved, and the cooking process has ended. The processor 150 may identify the time t1-t0 from the time when the fan 130 starts operating to the time when the cooking process ends as the cooking time of the cooking object 1. In this case, the processor 150 may identify the usage time of the filter 140 by applying the first correction coefficient to either of the running time t2-t0 of the fan 130 and the cooking time t1-t0.

In one example, when the cooking time of the food is equal to or less than the running time of the fan 130, the processor 150 may apply the first correction coefficient to the cooking time of the food, and when the cooking time of the food is greater than the running time of the fan 130, the processor 150 may apply the first correction coefficient to the running time of the fan 130.

Referring back to FIG. 8, the processor 150 may identify the usage time of the filter 140 by applying the first correction coefficient 1.2 to the cooking time t1-t0 which has a smaller value among the running time t2-t0 of the fan 130 and the cooking time t1-t0. Meanwhile, although not shown in the drawing, the processor 150 may also identify the second correction coefficient based on the rotation speed of the fan 130 during the cooking time t1-t0, and apply the second correction coefficient together with the first correction coefficient to the cooking time t1-t0 to identify the usage time of the filter 140.

Meanwhile, according to an embodiment, when the processor 150 identifies that it is time to replace the filter 140, the processor 150 may provide a notification indicating that it is time to replace the filter 140.

In one example, the processor 150 may display information on a display of the range hood 100 requesting that the filter 140 be replaced, thereby providing a notification indicating that it is time to replace the filter 140.

In addition, in one example, the processor 150 may providing a notification indicating that it is time to replace the filter 140 by outputting a warning sound through a speaker of the range hood 100 or outputting a voice requesting replacement of the filter 140.

Further, in one example, the processor 150 may provide a notification indicating that it is time to replace the filter 140 by transmitting information indicating that it is time to replace the filter 140 or information requesting that the filter 140 be replaced to a user terminal that is linked to the range hood 100 via the communication interface 120.

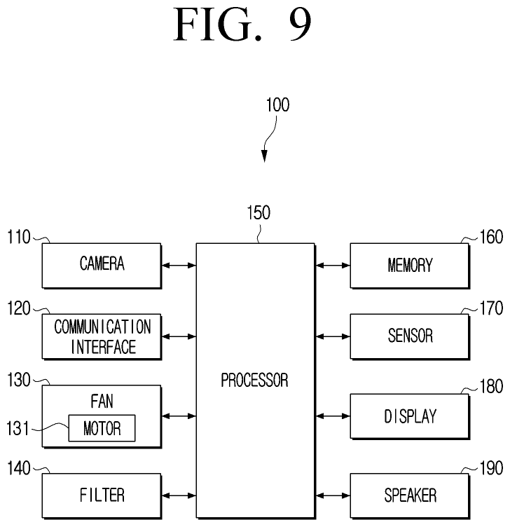

FIG. 9 is a detailed block diagram illustrating configuration of a range hood according to an embodiment of the disclosure.

Referring to FIG. 9, the range hood 100 according to an embodiment includes the camera 110, the communication interface 120, the fan 130, a motor 131, the filter 140, a memory 160, a sensor 170, a display 180, and a speaker 190. The configurations shown in FIG. 9 that are duplicative of the configurations shown in FIG. 2 will not be described in detail.

The motor may constitute the driving unit of the range hood 100 together with the fan 130. In this case, upon receiving a user input for controlling a rotation speed of the fan 130, the processor 150 may control the rotation speed of the motor by transmitting to the motor an electrical signal of a size corresponding to the rotation speed of the fan 130 set by the processor 150 according to a user input. Meanwhile, the processor 150 may identify a rotation speed of the fan 130 based on the rotation speed of the motor, and may identify the second correction coefficient corresponding to the identified rotation speed of the fan 130.

The memory 160 may store data required for various embodiments of the disclosure. The memory 160 may be implemented as a memory embedded in the range hood 100 or as a memory detachable from the range hood 100 depending on the data storage purpose.

For example, in the case of data for driving the range hood 100, the data is stored in the memory embedded in the range hood 100, and in the case of data for the expansion function of the range hood 100, the data may be stored in the memory detachable from the range hood 100. Meanwhile, The memory embedded in the range hood 100 may be implemented as at least one of a volatile memory (e.g. a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)). The memory detachable from the range hood 100 may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

In one example, the memory 160 may store a computer program including at least one instruction or a set of instructions for controlling the range hood 100.

In particular, the memory 160 stores cumulative usage time information of the filter 140. The processor 150 may reset the cumulative usage time information of the filter 140 whenever the filter 140 is replaced.

In addition, according to an embodiment, the memory 160 may store the table 20 including a plurality of correction coefficients for a plurality of food types and cooking methods, the neural network model 30 trained to output the first correction coefficient when a type of food and a cooking method are input, and the table 40 including a plurality of correction coefficients corresponding to a plurality of rotation speeds of the fan 130.

The sensor 170 may detect a concentration of smoke generated in the cooking container 2. To this end, the sensor 170 may include a smoke sensor. Further, the sensor 170 may measure the contamination level of the air quality of the air being drawn into the range hood 100 or the surrounding air of the range hood 100. To this end, the sensor 170 may include an air quality measurement sensor.

Meanwhile, the sensor 170 includes a temperature sensor, and when the temperature is equal to or greater than a preset temperature, may identify that cooking has started after the cooking container 2 is placed on a heating device disposed on the top of the cooking appliance 200. Accordingly, when it is identified that cooking has started, the processor 150 may obtain the image 10 of the cooking container 2 and the cooking object 1 in the cooking container 2 through the camera 110.

The display 180 may display various visual information. In particular, the processor 150 may display notification information via the display 180 indicating that it is time to replace the filter 140.

To this end, the display 180 may be implemented as a display including a self-luminous element or a display including a non-luminous element and a backlight. For example, the display 180 is implemented as various types of displays such as a Liquid Crystal Display (LCD), an Organic Light Emitting Diodes (OLED) display, a Light Emitting Diodes (LED), a micro LED, a Mini LED, a Plasma Display Panel (PDP), a Quantum dot (QD) display, a Quantum dot light-emitting diodes (QLED), etc.

The display 180 may also include a driving circuit, a backlight unit, and the like, which may be implemented in the form of a-si TFTs, low temperature poly silicon (LTPS) TFTs, organic TFTs (OTFTs), and the like. Meanwhile, the display 180 may be implemented as a touch screen combined with a touch sensor, a flexible display, a rollable display, a three-dimensional (3D) display, a display in which a plurality of display modules are physically connected.

Meanwhile, when the display 180 is implemented as a touch screen, the display 180 may function as an output unit that outputs information between the range hood 100 and the user, and at the same time, may function as an input unit that provides an input interface between the range hood 100 and the user.

The speaker 190 may output an acoustic signal to the outside of the range hood 100. The processor 150 may output a notification sound or voice message via the speaker 190 to indicate that it is time to replace the filter 140.

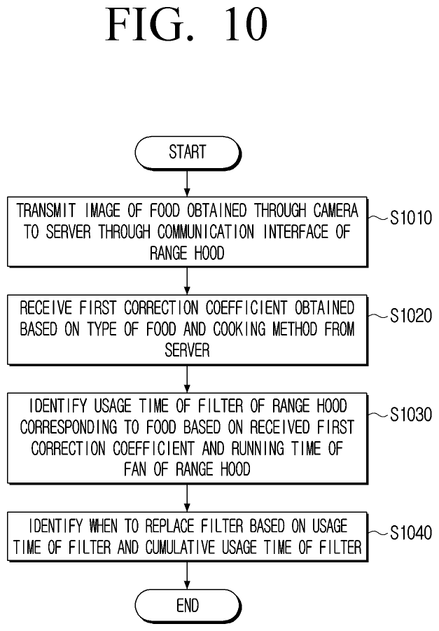

FIGS. 10 to 13 are flowcharts provided to explain a controlling method of a range hood including a camera according to various embodiments of the disclosure.

Referring to FIG. 10, the processor 150 performing a controlling method of the range hood 100 including the camera 110 according to an embodiment transmits the image 10 of the cooking object 1 obtained through the camera 110 to the server 300 via the communication interface 120 of the range hood 100.

Subsequently, the processor 150 receives from the server 300 the first correction coefficient obtained based on the type of food and the cooking method corresponding to the cooking object 1.

According to an embodiment, the first correction coefficient may be a correction coefficient corresponding to the type of food and the cooking method identified based on the image 10 from among a plurality of correction coefficients corresponding to a plurality of food types and cooking methods. For example, in the table 20 shown in FIG. 4, the correction coefficient corresponding to the type of food and the cooking method corresponding to the cooking object 1 in the image 10 transmitted by the processor 150 is identified by the server 300 as the first correction coefficient.

Further, according to an embodiment, the first correction coefficient may be obtained by inputting the type of food and the cooking method obtained from the image 10 into the neural network model 30 that is trained based on a type of food and a cooking method and a correction coefficient corresponding to the type of food and the cooking method.

Meanwhile, the processor 150 identifies the usage time of the filter 140 of the range hood 100 corresponding to the food based on the received first correction coefficient and the running time of the fan 130 of the range hood 100. The filter 140 is configured to purify air that is drawn into the range hood 100 by driving the fan 130.

Subsequently, the processor 150 identifies when to replace the filter 140 based on the identified usage time of the filter 140 and the cumulative usage time of the filter 140. In this case, when the processor 150 identifies that it is time to replace the filter 140, the processor 150 may provide a notification indicating that it is time to replace the filter 140.

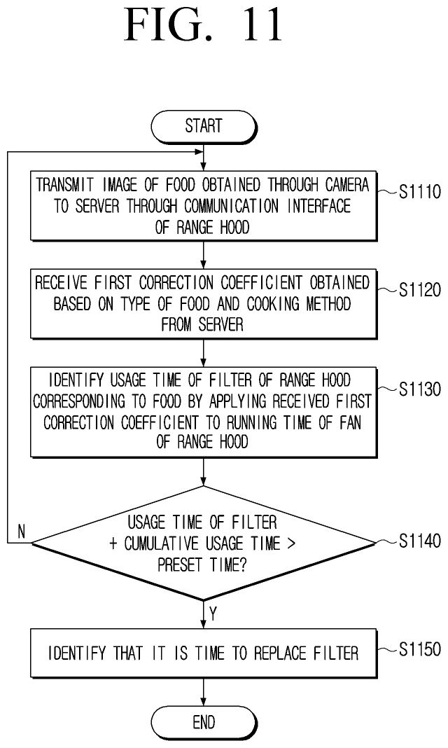

Referring to FIG. 11, operations S1110 and S1120 shown in FIG. 11 may correspond to operations S1010 and S1020 shown in FIG. 10. Accordingly, a detailed description thereof will be omitted.

Referring to FIG. 11, the processor 150 may receive the first correction coefficient from the server 300 via the communication interface 120 at operation S1120 and then apply the received first correction coefficient to the running time of the fan 130 of the range hood 100 to identify the usage time of the filter 140 at operation S1130.

Subsequently, the processor 150 identifies whether the sum of the usage time of the filter 140 and the cumulative usage time of the filter 140 is equal to or greater than a preset time at operation S1140.

In this case, when the sum of the usage time of the filter 140 and the cumulative usage time of the filter 140 is equal to or greater than the preset time, the processor 150 may identify that it is time to replace the filter 140 at operation 81150.

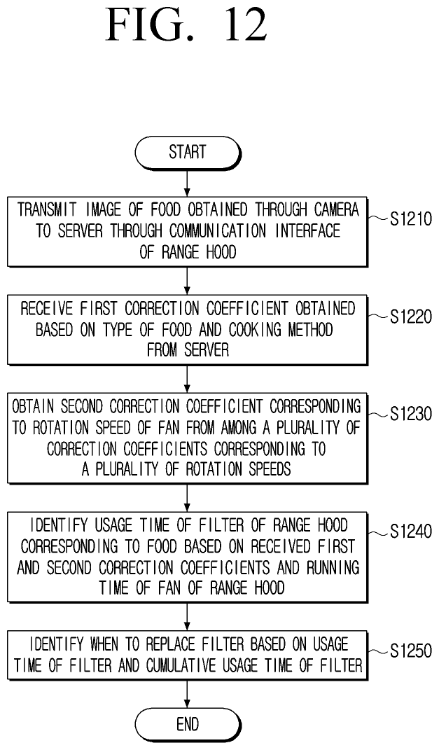

Referring to FIG. 12, operations S1210, S1220, and S1250 shown in FIG. 12 may correspond to operations S1010, S1020, and S1040 shown in FIG. 10, respectively. Accordingly, a detailed description thereof will be omitted.

Referring to FIG. 12, the processor 150 may obtain the second correction coefficient corresponding to the rotation speed of the fan 130 from among correction coefficients corresponding to a plurality of rotation speeds to identify the usage time of the filter 140 (81230). In addition, the processor 150 may identify the usage time of the filter 140 corresponding to the food based on the first and second correction coefficients and the running time of the fan 130 at operation S1240.

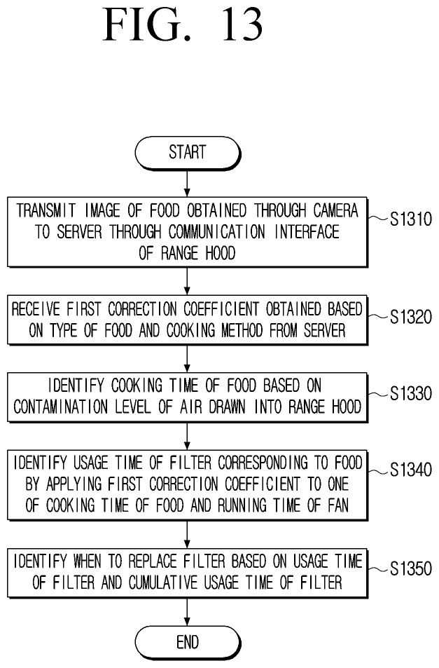

Referring to FIG. 13, operations S1310, S1320, and S1350 shown in FIG. 13 may correspond to operations S1010, S1020, and S1040 shown in FIG. 10, respectively. Accordingly, a detailed description thereof will be omitted.

Referring to FIG. 13, the processor 150 may identify the cooking time of the cooking object 1 based on the contamination level of the air being drawn into the range hood 100 to identify the usage time at operation S1330. In addition, the processor 150 may identify the usage time of the filter 140 corresponding to the food by applying the first correction coefficient to one of the cooking time of the cooking object and the running time of the fan 130 at operation S1340.

In this case, when the cooking time of the food is equal to or greater than the running time of the fan 130, the processor 150 may apply the first correction coefficient to the cooking time of the cooking object 1, and when the cooking time of the food is greater than the running time of the fan 130, apply the first correction coefficient to the running time of the fan 130.

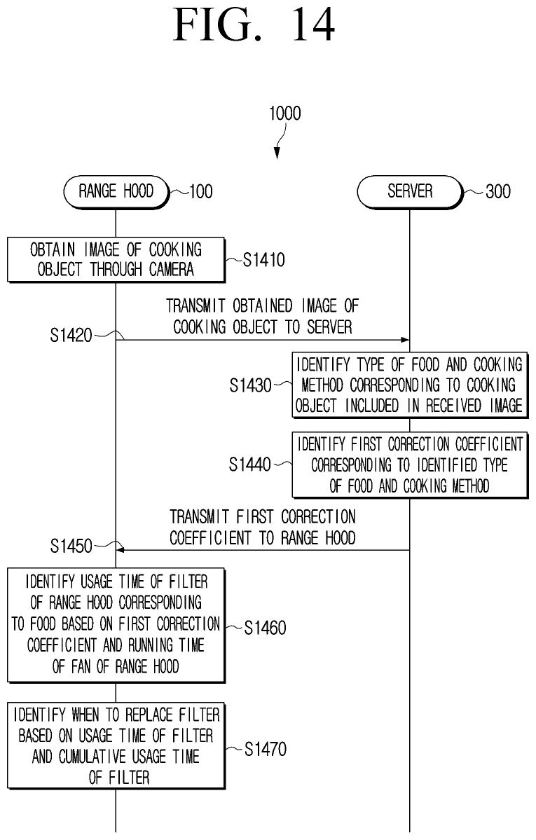

FIG. 14 is a sequence view provided to explain an operation between a range hood including a camera included in a cooking system and a server according to an embodiment of the disclosure.

Referring to FIG. 14, a cooking system 1000 according to an embodiment includes the range hood 100 and the server 300. The range hood 100 included in the cooking system 1000 is a range hood that includes a camera according to an embodiment described above, and the server included in the cooking system 1000 is a server that is linked to the range hood including a camera according to an embodiment described above.

The range hood 100 of the cooking system 1000 obtains an image of a cooking object through a camera (S1410), and transmits the obtained image of the cooking object to the server 300 (S1420). Upon receiving the image of the cooking object, the server 300 identifies a type of food corresponding to the cooking object and a cooking method (S1430). In this case, the server 300 may input the received image into a neural network model to identify the type of food and the cooking method.

Meanwhile, the server 300 may identify the first correction coefficient corresponding to the identified food type and cooking method (S1440).

Specifically, the server 300 may obtain the first correction coefficient by inputting the type of food and cooking method identified based on the image into a neural network model trained based on a type of food and a cooking method and a correction coefficient corresponding to the type of food and the cooking method. In this case, the neural network model may be stored in the memory of the server 300.

Further, the server 300 may identify, from among a plurality of correction coefficients corresponding to a plurality of food types and cooking methods, a correction coefficient corresponding to the type of food and cooking method identified based on the image as the first correction coefficient. Specifically, the server 300 may identify the first correction coefficient based on the table 20 that includes a plurality of correction coefficients corresponding to a plurality of food types and cooking methods.

The server 300 may transmit the identified first correction coefficient to the range hood. Subsequently, the range hood 100 may identify a usage time of a filter based on the received first correction coefficient, and may identify when to replace the filter. In this regard, the embodiments of the disclosure described above can be equally applied.

Meanwhile, the above-described various embodiments may be implemented in a recording medium that can be read by a computer or a similar device using software, hardware, or a combination thereof. In some cases, embodiments described herein may be implemented by a processor itself. According to software implementation, embodiments such as procedures and functions described in this specification may be implemented as separate software modules. Each of the software modules may perform one or more functions and operations described in this disclosure.

Meanwhile, computer instructions for performing processing operations of an electronic device according to the above-described various embodiments may be stored in a non-transitory computer-readable medium. When being executed by a processor of a specific device, the computer instructions stored in such a non-transitory computer-readable medium allows the specific device to perform processing operations in the range hood 100 according to the above-described various embodiments.

The non-transitory computer-readable medium refers to a medium that stores data semi-permanently and can be read by a device, rather than a medium that stores data for a short period of time, such as registers, caches, memory, etc. Specific examples of the non-transitory computer-readable medium may include CD, DVD, hard disk, Blu-ray disk, USB, memory card, ROM, etc.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A range hood, comprising:
a camera;
a communication interface;
a fan;
a filter for purifying air drawn into the range hood by driving the fan;
memory storing one or more computer programs; and
one or more processors communicatively coupled to the camera, the communication interface, the fan, the filter, and the memory,
wherein the one or more computer programs include computer-executable instructions that, when executed by the one or more processors individually or collectively, cause the range hood to:
transmit an image of a cooking object obtained through the camera to a server via the communication interface,
based on a first correction coefficient obtained based on a type of food and a cooking method corresponding to the cooking object being received from the server, identify a usage time of the filter corresponding to the food based on the first correction coefficient and a running time of the fan, and
identify when to replace the filter based on the usage time of the filter and a cumulative usage time of the filter.

2. The range hood of claim 1, wherein the first correction coefficient is obtained by inputting a type of food and a cooking method obtained from the image into a neural network model that is trained based on a type of food, a cooking method, and a correction coefficient corresponding to a type of food and a cooking method.

3. The range hood of claim 1, wherein the first correction coefficient is a correction coefficient corresponding to a type of food and a cooking method identified based on the image from among a plurality of correction coefficients corresponding to a plurality of food types and cooking methods.

4. The range hood of claim 1, wherein the one or more computer programs further include computer-executable instructions that, when executed by the one or more processors individually or collectively, cause the range hood to identify a usage time of the filter by applying the first correction coefficient to a running time of the fan, and based on a sum of the usage time or the filter and the cumulative usage time of the filter being equal to or greater than a preset time, identify that it is time to replace the filter.

5. The range hood of claim 1, wherein the one or more computer programs further include computer-executable instructions that, when executed by the one or more processors individually or collectively, cause the range hood to:
obtain a second correction coefficient corresponding to a rotation speed of the fan from among a plurality of correction coefficients corresponding to a plurality of rotation speeds, and
identify a usage time of the filter corresponding to the food based on the first and second correction coefficients and a running time of the fan.

6. The range hood of claim 1, wherein the one or more computer programs further include computer-executable instructions that, when executed by the one or more processors individually or collectively, cause the range hood to:
identify a cooking time of the cooking object based on a contamination level of air drawn into the range hood, and
identify a usage time of the filter corresponding to the cooking object by applying the first correction coefficient to one of a cooking time of the food and a running time of the fan.

7. The range hood of claim 6, wherein the one or more computer programs further include computer-executable instructions that, when executed by the one or more processors individually or collectively, cause the range hood to:
based on a cooking time of the cooking object being less than a running time of the fan, apply the first correction coefficient to a cooking time of the food, and
based on a cooking time of the cooking object being greater than a running time of the fan, apply the first correction coefficient to a running time of the fan.

8. The range hood of claim 1, wherein the one or more computer programs further include computer-executable instructions that, when executed by the one or more processors individually or collectively, cause the range hood to:
based on identifying that it is time to replace the filter, provide a notification indicating that it is time to replace the filter.

9. A controlling method performed by a range hood including a camera, the method comprising:
transmitting, by the range hood, an image of a cooking object obtained through the camera to a server through a communication interface of the range hood;
receiving, by the range hood, a first correction coefficient obtained based on a type of food and a cooking method corresponding to the cooking object from the server;
identifying, by the range hood, a usage time of a filter of the range hood corresponding to the food based on the first correction coefficient and a running time of a fan of the range hood; and
identifying, by the range hood, when to replace the filter based on the usage time of the filter and a cumulative usage time of the filter.

10. The method of claim 9, wherein the first correction coefficient is obtained by inputting a type of food and a cooking method obtained from the image into a neural network model that is trained based on a type of food, a cooking method, and a correction coefficient corresponding to a type of food and a cooking method.

11. The method of claim 9, wherein the first correction coefficient is a correction coefficient corresponding to a type of food and a cooking method identified based on the image from among a plurality of correction coefficients corresponding to a plurality of food types and cooking methods.

12. The method of claim 9, wherein the identifying when to replace comprises:
identifying a usage time of the filter by applying the first correction coefficient to a running time of a fan of the range hood; and
based on a sum of the usage time or the filter and the cumulative usage time of the filter being equal to or greater than a preset time, identifying that it is time to replace the filter.

13. The method of claim 9, wherein the identifying a usage time of the filter comprises:
obtaining a second correction coefficient corresponding to a rotation speed of the fan from among a plurality of correction coefficients corresponding to a plurality of rotation speeds; and
identifying a usage time of the filter corresponding to the food based on the first and second correction coefficients and a running time of the fan.

14. The method of claim 9, wherein the identifying a usage time comprises:
identifying a cooking time of the cooking object based on a contamination level of air drawn into the range hood; and
identifying a usage time of the filter corresponding to the food by applying the first correction coefficient to one of a cooking time of the food and a running time of the fan.

15. The method of claim 14, further comprises:
based on a cooking time of the cooking object being less than a running time of the fan, apply the first correction coefficient to a cooking time of the food, and
based on a cooking time of the cooking object being greater than a running time of the fan, apply the first correction coefficient to a running time of the fan.

16. The range hood of claim 9, further comprising:
based on identifying that it is time to replace the filter, provide a notification indicating that it is time to replace the filter.

17. One or more non-transitory computer-readable storage media storing one or more computer programs including computer-executable instructions that, when executed by one or more processors of a range hood individually or collectively, cause the range hood to perform operations, the operations comprising:
transmitting, by the range hood, an image of a cooking object obtained through a camera to a server through a communication interface of the range hood;
receiving, by the range hood, a first correction coefficient obtained based on a type of food and a cooking method corresponding to the cooking object from the server;
identifying, by the range hood, a usage time of a filter of the range hood corresponding to the food based on the first correction coefficient and a running time of a fan of the range hood; and
identifying, by the range hood, when to replace the filter based on the usage time of the filter and a cumulative usage time of the filter.

18. The one or more non-transitory computer-readable storage media of claim 17, wherein the first correction coefficient is obtained by inputting a type of food and a cooking method obtained from the image into a neural network model that is trained based on a type of food, a cooking method, and a correction coefficient corresponding to a type of food and a cooking method.

19. The one or more non-transitory computer-readable storage media of claim 17, wherein the first correction coefficient is a correction coefficient corresponding to a type of food and a cooking method identified based on the image from among a plurality of correction coefficients corresponding to a plurality of food types and cooking methods.

20. The one or more non-transitory computer-readable storage media of claim 17, wherein the identifying when to replace comprises:
identifying a usage time of the filter by applying the first correction coefficient to a running time of a fan of the range hood; and
based on a sum of the usage time or the filter and the cumulative usage time of the filter being equal to or greater than a preset time, identifying that it is time to replace the filter.
